(19) United States
(12) Patent Application Publication
(10) Pub. No.: US 2018/0334082 A1
(43) Pub. Date: Nov. 22, 2018

(54) HEAT DISSIPATION DEVICE

(71) Applicant: KUN CHAU HUANG, Taipei City (TW)

(72) Inventor: KUN CHAU HUANG, Taipei City (TW)

(21) Appl. No.: 15/597,118

(22) Filed: May 16, 2017

(51) Int. Cl. B60Q 1/115; B62J 6/02; F21S 8/10

(52) U.S. Cl. CPC B60Q 1/115; B62J 6/02; F21S 48/1317; F21S 48/145; F21Y 2115/10; F21S 48/328; F21S 48/115; B60Q 2300/132; F21S 48/1225

(57) ABSTRACT

A vehicle head light capable of correcting projection angle automatically includes a head light body having a light head retaining seat and a reflective cup locked; a passive gear cover and a front end thereof being formed with a passive gear; a bearing fixing seat; a bearing being fixed in the bearing fixing seat; the passive gear cover being arranged within the bearing, a motor locked in the bearing fixing seat; a horizontal sensor and a controller serving to control rotation angle of the motor; and a driving gear combined to an output spindle of the motor. The horizontal sensor automatically detects rotation angle of the head light or the inclination of the body of the motorcycle and detection data is transferred out to cause the motor and the driving gear are driven to drive the head light body to correct the light projection angle or swing angle.

### FIELD OF THE INVENTION

The present invention is related to head lights, and in particular to a vehicle head light capable of correcting projection angle automatically, which is especially suitable for two wheel vehicles, or other moving carries with head light. By engagement of gear structure and driving, the light projection angle or swing angle of the head light body is corrected and thus the projection of the light is retain at an optimum horizontal or a right straight direction to assure the safety in driving.

### BACKGROUND OF THE INVENTION

Prior art two wheel vehicles, such as motorcycles or electric motive bicycles, are installed with head lights for illumination at night or in dark. With reference to FIG. 1, it is illustrated that a prior hear light is installed at a front end of a vehicle. No matter when the vehicle turns or inclined, the projection of the light will shift from a normal direction, see FIG. 2, which cannot correct with the directions or the inclination of the vehicle. The light cannot actually project to a desired coverage and moreover, the coverage of the projection will be reduced due to changes of the orientation of the light so as to induce insufficient illumination or bad sight view. Therefore the safety in traffic cannot be assured.

In the improvement, disclosed by the inventor of the present invention, the improvement structure includes a head light body, a retaining plate, a retaining seat and a driving motor. The body is an LED light body (including a heat dissipation module seat, an LED supporting frame, and LED lighting elements). The light elements are locked to a rear end of the LED light body by the retaining plate so that the retaining seat is used to combine the body and the driving motor. Furthermore, a horizontal sensor is used to detect the turning or the inclination of the heat light for correcting the projection or swinging of the head light projection.

In this prior art, the retaining plate is locked to a metal plate at a rear end of the head light body. One surface thereof is adhered to the LED light emitting elements to have the effect of heat dissipation and a center of another surface thereof is installed with an axial ring to lock a bearing seat and the driving motor to two sides of the retaining seat. Therefore when the driving motor is driven, the head light body is driven to rotate or swing to correct the projection angle of the emission light. I

In above structure, the structure is complicated and many elements must be made specially, for example, the retaining plate and the retaining seat, etc. Furthermore, the time period for assembly is long so as to increase the cost. Moreover, the driving operation is realized by a motor to directly drive the heat light and thus the structural strength is weak and the whole structure is long, which is difficult to assembly it. As a result, the production rate is low. All these defects are necessary to be improved.

### SUMMARY OF THE INVENTION

Accordingly, the object of the present invention is to provide a vehicle head light capable of correcting projection angle automatically, wherein when the vehicle installed with the present invention will cause the projecting light is completely projected to the ground when the body of the vehicle turns or tilt. The projection surface of the light will not reduce to an oblong shape due to the inclination of the vehicle.

To achieve above object, the present invention provides a vehicle head light capable of correcting projection angle automatically, comprising: a head light body having a light head retaining seat and a reflective cup locked to a rear end of the light heat retaining seat; a passive gear cover having an annular structure which is combined to a rear end of the reflective cup of the head light body; a front end of the passive gear cover being formed with a passive gear; a bearing fixing seat covering around the passive gear cover; a bearing being fixed in the bearing fixing seat; the passive gear cover being arranged within the bearing, and the passive gear cover freely rotating within the bearing; a motor locked in the bearing fixing seat; a horizontal sensor and a controller serving to control rotation angle of the motor; and a driving gear combined to an output spindle of the motor and engaged with the passive gear of the passive gear cover so that the motor can synchronously drive the driving gear to synchronously drive the passive gear cover and thus synchronously drive the head light body; and wherein the horizontal sensor automatically detects rotation angle of the head light or the inclination of the body of the motorcycle and detection data is transferred out to cause the motor and the driving gear are driven to further drive the passive gear of the passive gear cover so as to drive the head light body to correct the light projection angle or swing angle and thus the projection of the light is retain at an optimum horizontal or a right straight direction to assure the safety in driving.

### BRIEF DESCRIPTION OF THE DRAWINGS

FIG. 1 is an assembly view of a prior art head light.

FIG. 2 shows the head light projection, when the vehicle having the head light tilting rightwards.

FIG. 3 is an exploded perspective view of the present invention.

FIG. 4 is an assembly view of the present invention.

FIG. 5 is an assembly lateral view of the present invention.

FIG. 6 is an upper assembly view of the present invention.

FIG. 7 is a front assembly view of the present invention.

FIG. 8 is an assembly perspective view showing the light head seat casing of the present invention.

FIG. 9 is an upper perspective view showing the light head seat casing of the present invention.

FIG. 10 shows the states before the vehicle is tilt leftwards.

FIG. 11 shows the states after the vehicle is tilt leftwards.

FIG. 12 shows the states before the vehicle is tilt rightwards.

FIG. 13 shows the states after the vehicle is tilt rightwards.

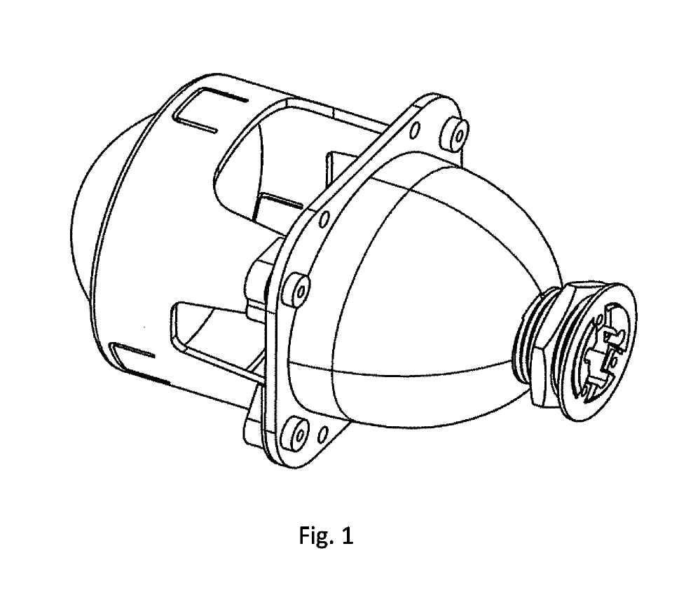

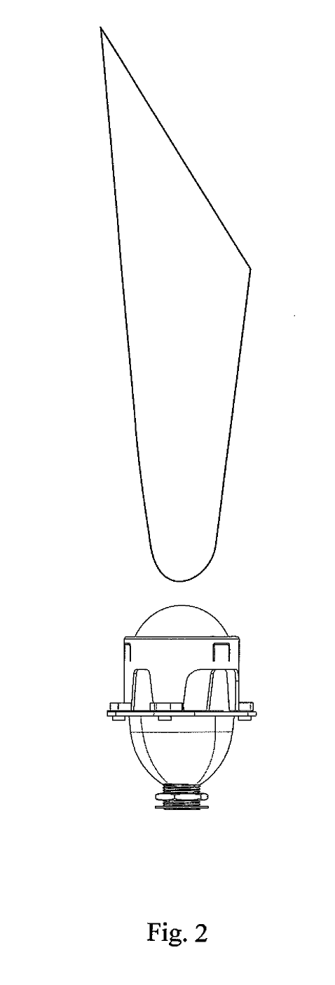

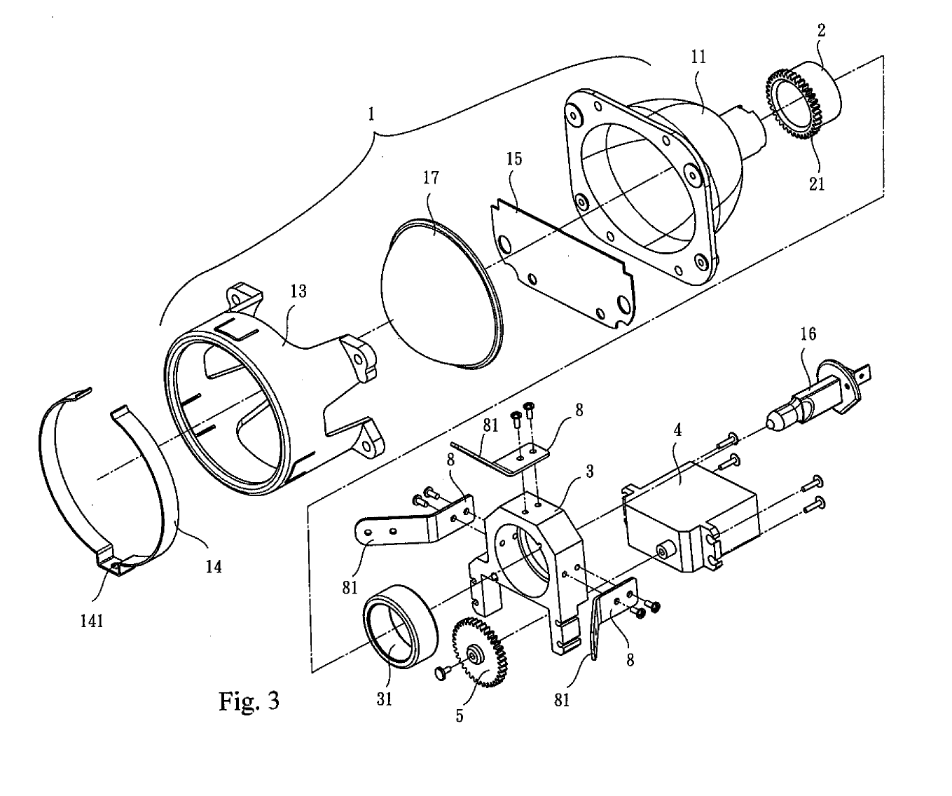

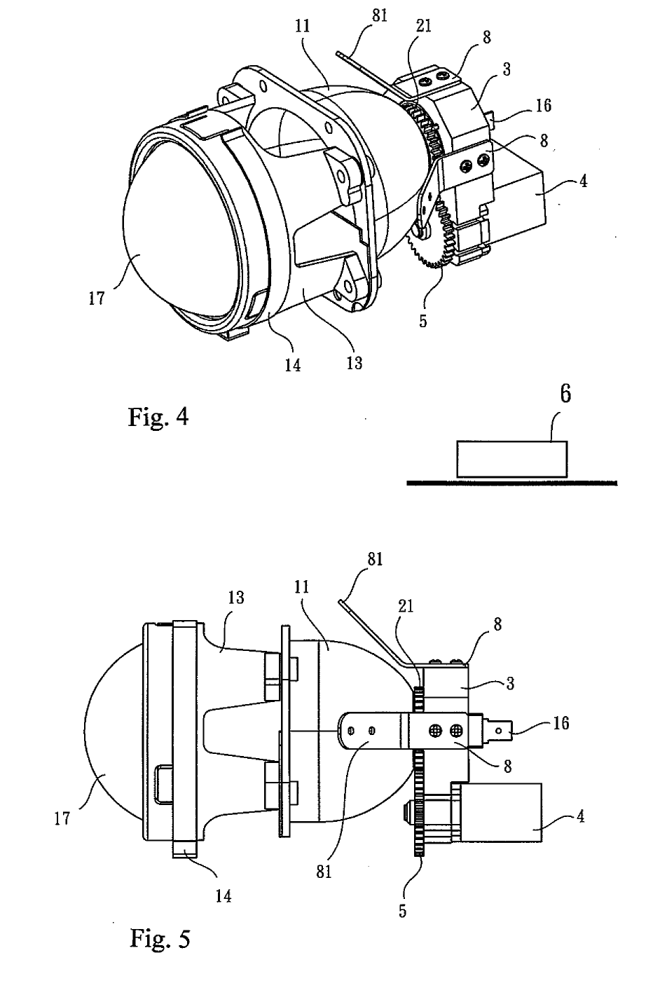

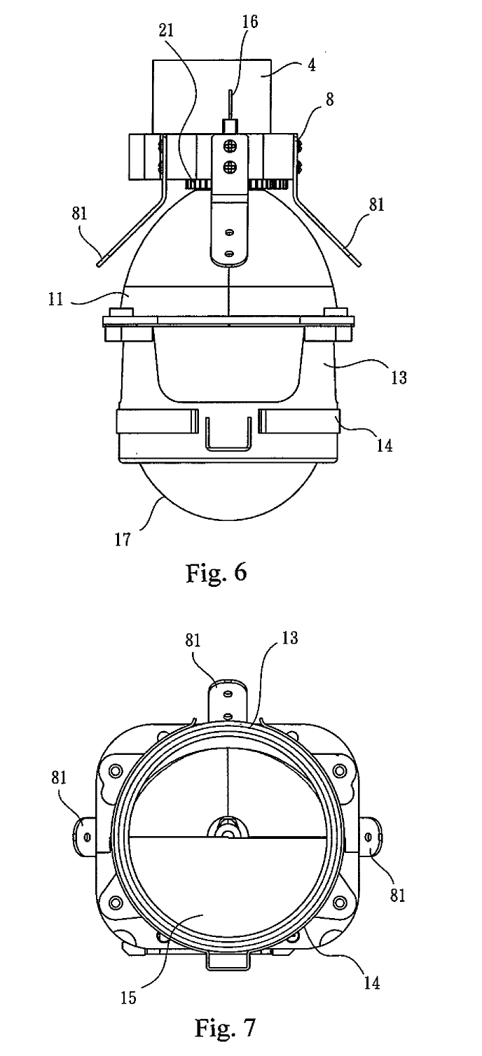

FIG. 4 shows the projection of the light when the vehicle tilt rightwards.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A head light body 1 is for example, a prior art light head light body or an LED light head light body, but this is not used to confine the scope of the present invention. The head light body 1 has a light head retaining seat 13 and a reflective cup 11 locked to a rear end of the light heat retaining seat 13. A light shielding sheet 15, a bulb 16 and a lens 17 are contained with the head light body 1 for constructing a head light for a vehicle, however, the construction of the light shielding sheet 15, the bulb 16 and the lens 17 are knows in the prior art, and thus the detailed with not be further described herein.

A passive gear cover 2 has an annular structure which is combined to a rear end of the reflective cup 11 of the head light body 1. A front end of the passive gear cover 2 is formed with a passive gear 21.

A bearing fixing seat 3 covers around the passive gear cover 2. A bearing 31 is fixed in the bearing fixing seat 3. The passive gear cover 2 is arranged within the bearing 31, while the passive gear cover 2 freely rotates within the bearing 31.

A motor 4 is locked in the bearing fixing seat 3 (the drawing shows that the motor 4 is located at a lower side of the bearing fixing seat 3). A horizontal sensor 6 and a controller 7 serve to control the rotation angle of the motor 4. The motor 4 is a servo motor, a step motor, or driving motors of other types. All these are not used to confine the scope of the present invention.

A driving gear 5 is combined to an output spindle of the motor 4 and is engaged with the passive gear 21 of the passive gear cover 2 so that the motor 4 can synchronously drive the driving gear 5 to synchronously drive the passive gear cover 2 and thus synchronously drive the head light body 1.

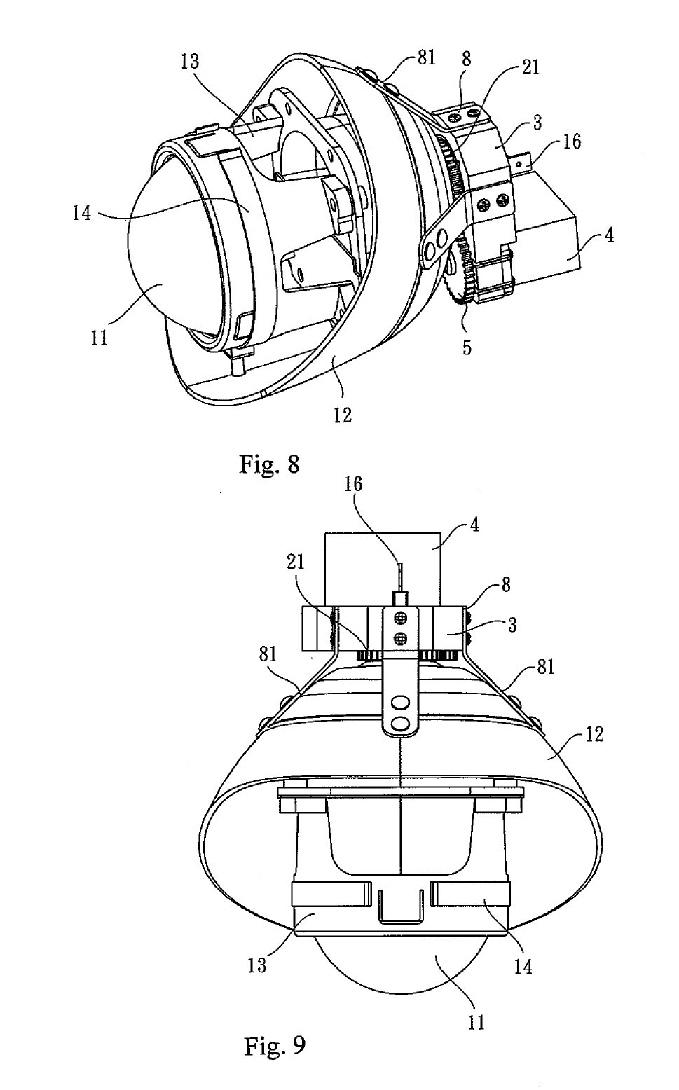

Furthermore, in the present invention, the bearing fixing seat 3 may be locked with at least one fixing claw 8. One end of each fixing claw 8 is locked to an outer sidewall of the bearing fixing seat 3 and another end thereof is formed with an extension portion 81 which is bent and adhered to a rear side of the head light body 1. All the extension portions 81 are formed as a bowl shape for enclosing the rear wall of the head light body 1. All the fixing claws 8 are spaced with proper spaces. Referring to FIGS. 8 and 9, thereby the bearing fixing seat 3 can fixedly combined to the light seat casing 12.

Thereby, by above mentioned structure, a head light carrier capable of automatically correcting light projection angle is formed.

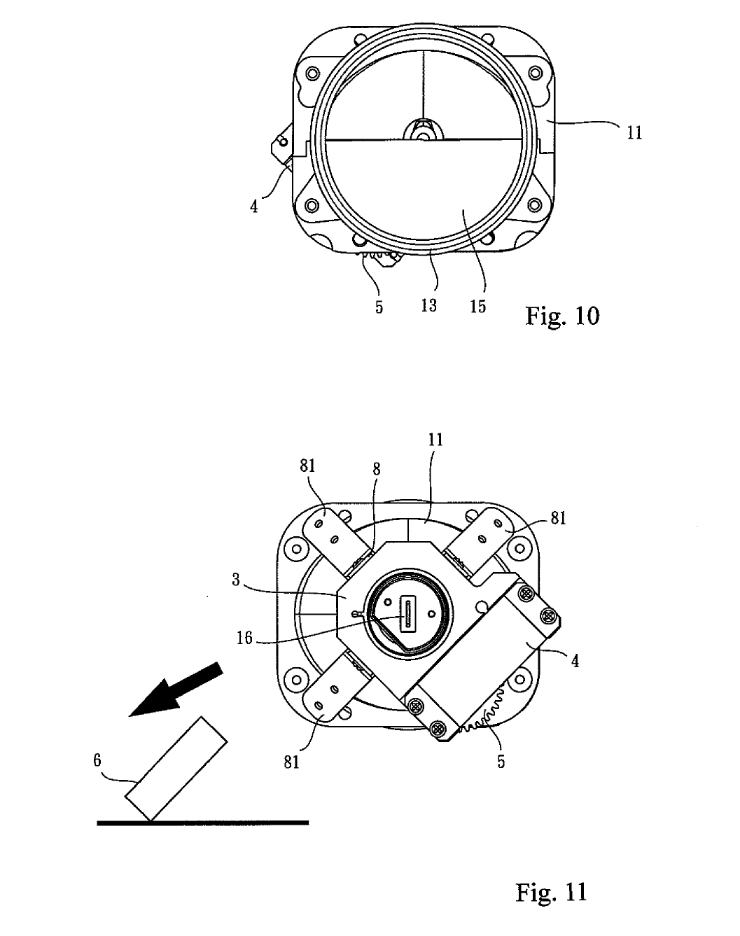

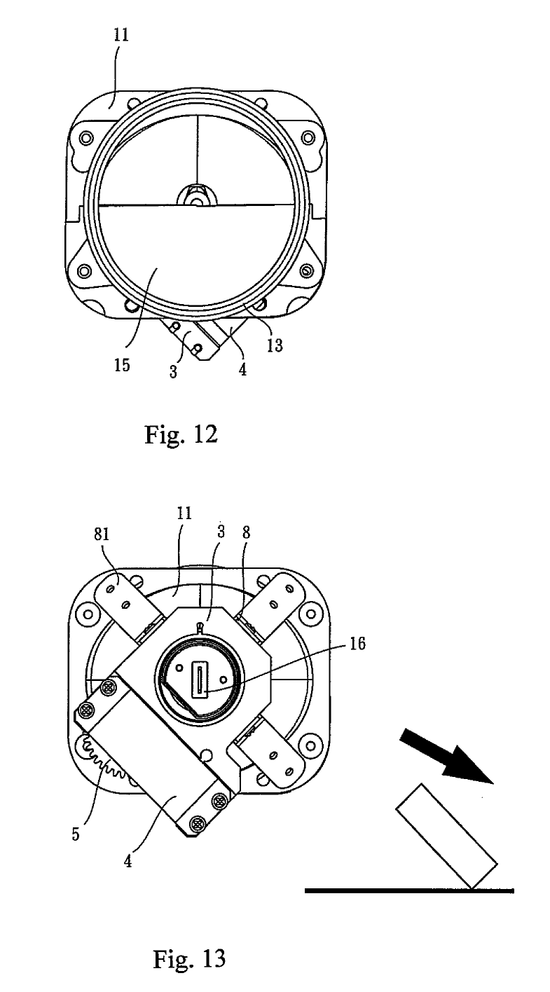

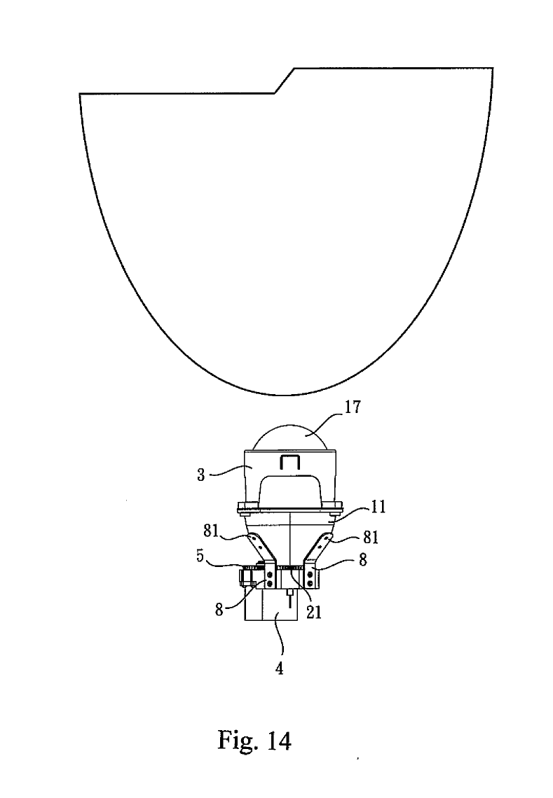

The horizontal sensor 6 will automatically detect rotation angle of the head light (for example, of a motorcycle) or the inclination of the body of the motorcycle, and the detection data is transferred out to cause the motor 4 and the driving gear 5 are driven to further drive the passive gear 21 of the passive gear cover 2 so as to drive the head light body 1 to correct the light projection angle or swing angle (see FIGS. 10 and 11) to assure the projection of the light to retain an optimum horizontal or a right straight direction to assure the safety in driving. FIGS. 10 and 11 shows the states before and after the vehicle is tilt leftwards. FIGS. 12 and 13 shows the states before and after the vehicle is tilt rightwards. Therefore, the present invention can assure that the headlight always projects light in an optimum and right direction to enhance safety in driving.

Furthermore, in the present invention, a C elastic clip 14 can be engaged to an outer annular wall at a front end of the light head retaining seat 13. A predetermined section (such as a lower side) of the C elastic clip 14 is protruded with a lock portion 141 for locking the C elastic clip 14 to the light seat casing 12 for positioning a front end of the head light body 1 (However, the locking portion 141 of the C elastic clip 14 does not penetrate through the light seat casing 12 and thus the C elastic clip 14 only has the effect of positioning. It will not affect the correction of turning of the head light body 1). Therefore, the front and rear ends of the head light body 1 can be well retained to avoid the shaking and vibration of the elements thereof and thus release therefrom. The head light body 1 is a general vehicle light, while the difference is that the rear end of the reflective cup 11 of the head light body 1 is fixedly combined with the passive gear cover 2, while in the prior art, the vehicle light has a light shielding sheet 15, a bulb 16 and a lens 17. All these are known in the prior art.

In the present invention, when the vehicle installed with the present invention will cause the projecting light is completely projected to the ground when the body of the vehicle turns or tilt, as illustrated in FIG. 14. The projection surface of the light will not reduce to an oblong shape due to the inclination of the vehicle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle head light capable of correcting projection angle automatically, comprising:
a head light body having a light head retaining seat and a reflective cup locked to a rear end of the light heat retaining seat;
a passive gear cover having an annular structure which is combined to a rear end of the reflective cup of the head light body; a front end of the passive gear cover being formed with a passive gear;
a bearing fixing seat covering around the passive gear cover; a bearing being fixed in the bearing fixing seat; the passive gear cover being arranged within the bearing, and the passive gear cover freely rotating within the bearing;
a motor locked in the bearing fixing seat; a horizontal sensor and a controller serving to control rotation angle of the motor; and
a driving gear combined to an output spindle of the motor and engaged with the passive gear of the passive gear cover so that the motor can synchronously drive the driving gear to synchronously drive the passive gear cover and thus synchronously drive the head light body; and
wherein the horizontal sensor automatically detects rotation angle of the head light or the inclination of the body of the motorcycle and detection data is transferred out to cause the motor and the driving gear are driven to further drive the passive gear of the passive gear cover so as to drive the head light body to correct the light projection angle or swing angle and thus the projection of the light is retain at an optimum horizontal or a right straight direction to assure the safety in driving.

2. The vehicle head light capable of correcting projection angle automatically as claimed in claim 1, wherein a C elastic clip is engaged to an outer annular wall at a front end of a light head retaining seat; and a predetermined section of the C elastic clip being protruded with a lock portion for locking the C elastic clip to the light seat casing.

3. The vehicle head light capable of correcting projection angle automatically as claimed in claim 1, wherein the bearing fixing seat is locked with at least one fixing claw; one end of each fixing claw is locked to an outer sidewall of the bearing fixing seat and another end thereof is formed with an extension portion which is bent and adhered to a rear side of the head light body; all the extension portions are formed as a bowl shape for enclosing the rear wall of the head light body; and all the fixing claws are spaced with proper spaces, thereby the bearing fixing seat are fixedly combined to the light seat casing.

4. The vehicle head light capable of correcting projection angle automatically as claimed in claim 1, wherein the motor is a servo motor.

5. The vehicle head light capable of correcting projection angle automatically as claimed in claim 1, wherein the motor is a step motor.
